(19) United States
(12) Patent Application Publication
(10) Pub. No.: US 2005/0124734 A1
(43) Pub. Date: Jun. 9, 2005

(54) Process for the introduction of additives, into polymer melts

(75) Inventors: Uwe Hucks, Alpen (DE); Thomas Konig, Leverkusen (DE); Melanie Mothrath, Dusseldorf (DE)

Correspondence Address: BAYER MATERIAL SCIENCE LLC, 100 BAYER ROAD, PITTSBURGH, PA, 15205, US

(73) Assignee: Bayer MaterialScience AG

(21) Appl. No.: 11/002,827

(22) Filed: Dec. 2, 2004

(30) Foreign Application Priority Data
Dec. 6, 2003 (DE) 10357182.5

(51) Int. Cl. C08K 3/00

(52) U.S. Cl. 523/351

(57) ABSTRACT

A process for making a thermoplastic molding composition comprising (i) forming a vertically falling stream of molten polymer, and (ii) bringing at least one additive in solid or liquid states, in solution, in the form of a dispersion or in suspension into contact with at least a part of the surface of said stream and to introduce the additive in said stream to produce combined stream, and (iii) introducing the combined stream into a pump to form a pre-mix and (iv) introducing the premix into a mixer to form a homogeneous polymer melt. The entraining stream is then introduced to a pump to form a pre-mix which is then introduced to a mixer to form a homogeneous polymer melt. The process results in a compositions having advantageous material properties.

### FIELD OF THE INVENTION

The invention relates to a process for preparation of thermoplastic molding compositions and more specifically to compositions that contain any of additives, catalysts or inhibitors.

### BACKGROUND OF THE INVENTION

There are numerous reasons why polymer melts should be mixed with additives. Such additives may improve properties of the polymers such as for example resistance to degradation (additives), may promote desired reactions for the further production or processing procedure (catalysts), or may suppress undesirable reactions (inhibitors).

The person skilled in the art knows that many additives, catalysts or inhibitors in pure form at the temperatures at which they are metered into the polymer melt may themselves experience undesirable changes such as chemical decomposition or decrease in desired properties. Also, additives, catalysts, or inhibitors may at high temperatures have a corrosive effect on the materials employed in the apparatus and equipment in which the products are handled, especially at high concentrations and before they are mixed with the melt. It is therefore desirable that the additives, catalysts or inhibitors have only a short residence time at high temperatures. In particular a long residence time at a high temperature in the unmixed state should be avoided in order to maintain the quality of the additive. In the case of corrosive additives, catalysts or inhibitors, contact at high temperature with the materials of the apparatus parts that are used should also be avoided.

An additive, catalyst or inhibitor is regarded as corrosive if, in the case of the materials that are normally used in the process and from which the plant parts are fabricated, it causes erosion of 0.1 mm/year or more due to chemical attack, and also produces stress cracks or pitting.

Additives, catalysts or inhibitors are as a rule solid or liquid.

Solid additives, catalysts or inhibitors are normally metered in through metering screws, spirals or scales with vibrating chutes. In order to introduce the substances into a polymer melt, these drop in free fall in open shafts of screws, kneaders or other apparatus underneath which the melt is located, which is in a state of movement or transportation. The additives, catalysts or inhibitors thereby introduced are transported together with the polymer melt into other regions of the apparatus and mixed together. A disadvantage is that an inertisation is possible only with high technical expenditure. In addition the metering of solids is susceptible to interference and is not always sufficiently accurate or constant.

Liquid additives, catalysts or inhibitors are conveyed and metered by means of pumps. One possible way of combining these with the polymer melt is the same as described above for solids.

The use of mixers without moving parts (static mixers) or extruders for mixing in additives, catalysts or inhibitors in polymer melts corresponds to the prior art. A use of static mixers for such purposes corresponding to the prior art is outlined in “Chemische Industrie”, 37(7), pp. 474-476.

DE 19 841 376 A1 describes a further process for mixing additives into polymers, in which the examples relate to polyesters and copolyesters. In this case a side stream is removed from the main stream, specifically by means of a planetary gear-type pump. The additives are fed in this connection in concentrated form directly to a gear wheel or a plurality of gear wheels of the planetary gear-type pump and are mixed further by means of a downstream-connected static mixer with the side stream and this in turn is mixed by means of a further static mixer with the main stream. The temperature level is fixed to that of the main stream, with the result that harmful reactions of the additives may occur at this temperature.

In DE 4 039 857 A1 a further process for mixing additives into a polymer stream is described, in which polyamide and polyester melts are preferred. In this, a side stream is removed from a main stream, the additives are mixed with the side stream with the aid of an extruder fed with melt, and are then mixed with the main stream with the aid of a static mixer. The disadvantage of this process is the unavoidable increase in the extruder of the temperature of a part of the main stream, which on the one hand may adversely affect the quality of the polymer and in turn allow undesirable secondary reactions of the additive components, of the additive components with one another or of the additive components with the polymer of the side stream and/or of the main stream.

Screw compounders alone may also be used for the mixing of polymers with additives, which are metered in liquid or solid form. This corresponds to the long-known prior art. An example of this is U.S. Pat. No. 5,972,273, in which a polycarbonate melt is mixed with the aid of an extruder with a mixture of polycarbonate and an additive.

All the above possibilities have the disadvantage that the additives, catalysts or inhibitors are in contact in concentrated form at high temperatures with the walls of the apparatus parts and then reach the polymer melt, whereby they suffer damage and therefore can no longer exert the full desired effect in the polymer.

In the procedure that is generally employed the melt lines for the additives, catalysts or inhibitors are led into the hot housings of the screws, kneaders or other apparatus so that the inflowing melts of the additives, catalysts or inhibitors are entrained by the polymer melt flowing past the connection point and are mixed in during the further course of the procedure. There are always regions of high concentration at this entry point. Due to the conduction of heat away from the screws, kneaders or apparatus that are always operating at a relatively high temperature, the entry points for the metering of the additives, catalysts or inhibitors are strongly overheated. On account of the minor amounts that are metered in, in the region of the part containing the pure additive, the pure catalyst or inhibitor, the residence times are high. This therefore often results in thermal damage to the additives, with discolorations or even carbonization and thus blockages. In addition the counter-pressures from the polymer melt region are often very high and variable, so that a clean and constant metering of the additives is difficult. Interruptions due to interference are the rule. Furthermore a flow plume or streamer of the additive, catalyst or inhibitor is formed at the entry point, which disappears only on entry into the static mixer or the shear field of a screw. The high thermal stress experienced by the additives, catalysts or inhibitors as well as the interference in the metering lead to significant losses of quality and deterioration of the products to be produced.

These disadvantages are avoided by the practice according to the invention.

If melts are conveyed under high pressures through pipelines and have to be mixed with additives, catalysts or inhibitors, the only option is to introduce the liquid substance through a directly connected line, generally against very high pressures.

A further possibility is to melt the polymers in a separate screw and introduce additives, catalysts or inhibitors, whether solid or liquid, as already described above. The melt is then fed to the main stream of the melt. The renewed melting of polymer granules adversely affects the quality as a rule and is therefore disadvantageous.

It is also known to use master batches. Master batches are mixtures of polymers with additives, catalysts or inhibitors in relatively high concentrations. They are prepared as a rule according to the method described in the preceding paragraph, though they still subsequently have to be granulated. A further disadvantage is that the master batch has to be remelted in order to be introduced into the polymer.

On the basis of the prior art, the object therefore exists of providing a process for the metering of additives, catalysts and inhibitors that avoids the disadvantages of the known processes.

### DESCRIPTION OF THE DRAWINGS

FIG. 1 is a schematic representation of a suitable device for the practice of the inventive process.

### SUMMARY OF THE INVENTION

A process for making a thermoplastic molding composition is disclosed. The process entails (i) forming a vertically falling stream of molten polymer, and (ii) bringing at least one additive into contact with at least a part of the surface of said stream and to introduce the additive in said stream to produce a combined stream, and (iii) introducing the combined stream into a pump to form a pre-mix and (iv) introducing the premix into a mixer to form a homogeneous polymer melt.

The combined stream is then introduced to a pump to form a pre-mix which is then introduced to a mixer to form a homogeneous polymer melt. The process results in a composition having advantageous material properties.

### DETAILED DESCRIPTION OF THE INVENTION

A surprisingly simple way has now been found for introducing one or more additives into a molten polymeric resin to produce a thermoplastic molding composition. The additive thus introduced may be in solid or liquid states, in solution or in the form of a dispersion or suspension and includes any compound known for its function in the context of the molding composition. Examples of such additive include catalysts, inhibitors, stabilizers and other compounds known in the art for their function in the context of the resinous polymer of interest. The process is characterized in that the introduction of the additive needs to avoid its prolonged exposure to elevated temperatures. As is well recognized such exposure often leads to unwanted reactions and/or degradation of the additive. The additives that are in liquid form are therefore preferably maintained at room temperature for as long as practical , the additives that are introduced in molten form are preferably kept as melt at as low a temperature as practical, while soluble additives and additives in the form of dispersions are likewise kept at the lowest practical temperature. The metering of the additive is carried out using a pump (for instance piston pumps, injection pumps, gear-type pumps) or any other known conveying device.

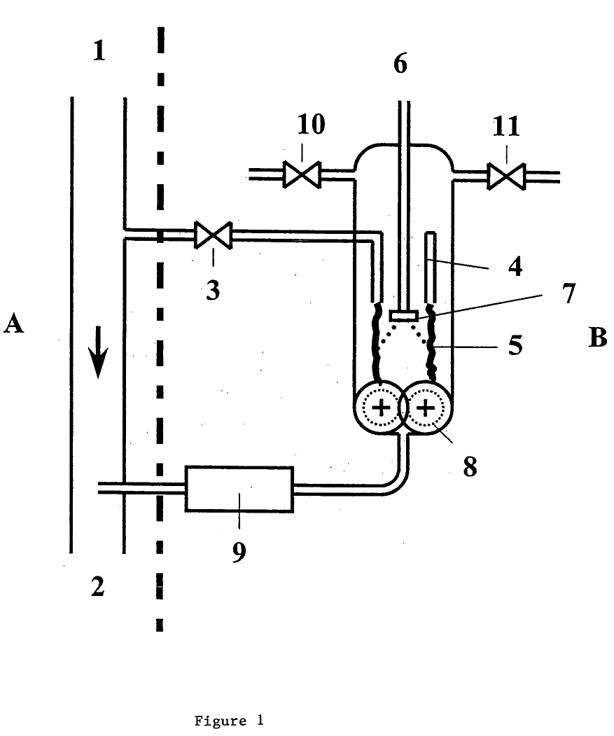

In a preferred embodiment presented schematically in FIG. 1, the inventive process entails forming, by using a suitable annular nozzle 4, a vertically falling hollow stream 5, (“hose”) of molten polymer, and introducing the additive inside the hose through suitable means such as a hollow cone nozzle 7. The temperature of the polymer melt (falling hollow stream) is depending on the polymer and the usual processing conditions and is usually between 150 to 350° C., preferably between 250 and 320° C., especially for polycarbonate. The temperature of the additive in the process which are used in the form of an aqueous solution dispersion suspension is lower than 100° C., preferably between 80 to lower than 100° C. The temperature of additives which are used in form of their melt is usually from 50 to 200° C. depending on the kind of additive and its melt temperature. In the practice of the inventive process, the temperature of the falling hollow stream is significantly higher than that of the additive.

The stream that now includes the entrained additive is introduced into a pump, for example gear pump, to form a pre-mix and the pre-mix is conveyed to a mixer, for instance a static mixer to form a homogeneous polymer melt. Degradation of the additive and unwanted reactions are practically eliminated with the characteristic short residence time at the high temperature and the avoidance of forming in the polymer of points of high additive concentration. The process according to the invention is particularly advantageous in the instances where at high temperatures the additive is corrosive (e.g. phosphoric acid) to the apparatus. In corresponding conventional processes the additive comes into contact with the material (usually metal) in which the mixing is carried out with the consequential corroding effect. Such corrosion is avoided in the practice of the invention because the additive comes into contact with the polymer directly, and only after it has been diluted by the polymer, comes into contact with the metal. In a further embodiment a spinning-disc atomiser or plate atomiser (rotating disc) is used to entrain the additive in the polymer melt.

Additives that cannot be melted or that decompose on melting may be dissolved in a suitable solvent. Preferably the solvent has a sufficiently low boiling point and is used in a sufficiently small amount such that upon contact with the hot thermoplastic melt it spontaneously evaporates without significant lowering of the temperature of the thermoplastic melt.

In the embodiment represented in FIG. 1, the hollow-cone nozzle, or in the corresponding embodiment the spinning-disc atomiser, is introduced from above into the annular nozzle to a depth such that the additive strikes the inside of the melt stream. The desired concentrations of additive in the polymer may be achieved by metered pumping of the additive.

It is advantageous in practice to maintain the additive at the lowest practical temperature until its contact with the polymer. During the metering only the pressure of the nozzle has to be overcome. When using a spinning-disc atomiser a metering may also be carried out without counter-pressure. In a yet additional embodiment air and water are excluded from the inventive process. The pressure in the system may be selected to suit the physical characteristics of the materials used in the process. For example, in an instance where the additive is in the form of an aqueous solution, the pressure may be adjusted such that the only a limited amount of water, preferably none at all, is introduced into the polymer. Thus, substances that have a relatively high vapor pressure in the pure state under the operating conditions may also readily be metered in. The pressure is chosen so as to prevent evaporation.

The process according to the invention thus permits a simple metering in of additives.

So as not to have to pass the entire main stream of the polymer melt through an annular nozzle, it is advantageous to branch off part of the stream, introduce the additive therein and then re-incorporate that additive-containing part into the main stream. In a yet additional embodiment the entire molten stream, and not merely a branch thereof, may be used to entrain the additive.

A preferred embodiment of the inventive process is illustrated schematically in FIG. 1. “A” represents a polymer melt line such as prepared by or processed in an extruder, a reactor or another apparatus or another device. From a melt without additive 1, there is branched off a partial stream through a valve 3 that is processed through an annular nozzle 4 to form a melt stream in the form of a hose 5.

The additive is fed through the line 6 with the hollow-cone nozzle 7. The polymer melt stream entraining the additive is conveyed and premixed in pump 8 and the resulting pre-mix conveyed through mixer 9 into the main melt stream to form stream 2. Optional inert gas is introduced through valve 10; the desired pressure may be adjusted by valve 11 that may also serve to discharge the optional evaporating solvent.

Pump 8 is advantageously a gear pump. Alternatively screws of widely varying design and construction or specially constructed displacement pumps may be employed.

All thermoplasts are suitable for use according to the invention. Particularly suitable are polycarbonates, polyesters, polyamides and their blends, polystyrene, copolymers of styrene and acrylonitrile and/or methyl methacrylate, blends of polystyrene or a copolymer of styrene and acrylonitrile with rubbers, preferably polybutadiene, polyethylene, copolymers of polyethylene with vinyl acetate or with α-olefins, polypropylene, thermoplastic polyurethanes. Preferred thermoplasts are polycarbonates, polyesters as well as their blends, polystyrene and copolymers of styrene and acrylonitrile, particularly preferred are polycarbonates and their blends.

Also suitable are solutions of polymers that cannot themselves be processed, such as for example rubbers, or spinning solutions, for example of polyacrylonitrile or elasthane (a polyurethane elastomer).

Suitable additives are all meltable, liquid or soluble compounds, in particular compounds soluble in solvents. These are therefore all the compounds that improve the properties of the polymers and products to be produced. Additives that serve to prolong the service life (e.g. stabilizers against hydrolysis or degradation), to improve the color stability (e.g. thermal and UV stabilizers), to simplify the processing (e.g. mold release agents, flow auxiliaries), to improve the use properties (e.g. antistatics), to improve the flame retardance, to influence the optical impression (e.g. organic colorants) or to match the polymer properties to specific stresses (impact strength modifiers). All these may be combined as necessary in order to achieve and adjust the desired properties. The suitable compounds are described for example in “Plastics Additives”, R. Gächter and H. Müller, Hanser Publishers 1983, in “Additives for Plastics Handbook”, John Murphy, Elsevier, Oxford 1999 or in “Plastics Additives Handbook”, Hans Zweifel, Hanser, Munich 2001.

The additives may be added individually or in any mixture or as several different mixtures to the polymer melt, and more particularly directly during the isolation of the polymer or after granules have been melted in a compounding step.

These substances may be added or metered according to the invention to the polymeric resin though, depending on requirements, they may however also be added or metered at another stage in the production process. The mixing with the polymer takes place in equipment known for this purpose, such as for example screw extruders or static mixers. The amount of additives which are metered by the present process is of 0,05 to 15 wt. %, preferably of 0,1 to 15 wt. %, more preferably 0,2 to 8 wt. % and in particular 0,2 to 5 wt. % (referred to the weight of the composition). In case a masterbatch of additive is produced by the present process the additives are metered in an amount of 1 to 15 wt. %, preferably of 3 to 10 wt. %. Otherwise the additives are usually metered to the polymer melt by 0,05 to 1,5, preferably 0,7 to 1 and most preferably 0,2 to 0,5 wt. %.

Suitable Additives which may be introduced into the polymer melt are as follows:
1. Suitable antioxidants include for example:
1.1. Alkylated monophenols, for example 2,6-di-tert.-butyl-4-methylphenol, 2-tert.-butyl-4,6-dimethylphenol, 2,6-di-tert.-butyl-4-ethylphenol, 2,6-di-tert.-butyl-4-n-butylphenol, 2,6-di-tert.-butyl-4-isobutylphenol, 2,6-dicyclopentyl-4-methyl-phenol, 2-(α-methylcyclohexyl)-4,6-dimethylphenol, 2,6-dioctadecyl-4-methyl-phenol, 2,4,6-tricyclohexylphenol, 2,6-di-tert.-butyl-4-methoxymethylphenol, nonylphenols that are linear or branched in the side chain, for example 2,6-dinonyl-4-methylphenol, 2,4-dimethyl-6-(1′-methylundec-1′-yl)-phenol, 2,4-di-methyl-6-(1′-methylheptadec-1′-yl)-phenol, 2,4-dimethyl-6-(1′-methyltridec-1′-yl)-phenol.
1.2. Alkylthiomethylphenols, for example 2,4-dioctylthiomethyl-6-tert.-butylphenol, 2,4-dioctylthiomethyl-6-methylphenol, 2,4-dioctylthiomethyl-6-ethylphenol, 2,6-didodecylthiomethyl-4-nonylphenol.
1.3. Hydroquinones and alkylated hydroquinones, for example 2,6-di-tert.-butyl-4-methoxyphenol, 2,5-di-tert.-butylhydroquinone, 2,5-di-tert.-amylhydroquinone, 2,6-diphenyl-4-octadecyloxyphenol, 2,6-di-tert.-butylhydroquinone, 2,5-di-tert.-butyl-4-hydroxyanisole, 3,5-di-tert.-butyl-4-hydroxyanisole, 3,5-di-tert.-butyl-4-hydroxyphenyl-stearate, bis-(3,5-di-tert.-butyl-4-hydroxyphenyl)-adipate.
1.4. Tocopherols, for example α-tocopherol, β-tocopherol, γ-tocopherol, δ-tocopherol and mixtures thereof (vitamin E).
1.5. Hydroxylated thiodiphenyl ethers, for example 2,2′-thiobis-(6-tert.-butyl-4-methylphenol), 2,2′-thiobis-(4-octylphenol), 4,4′-thiobis-(6-tert.-butyl-3-methyl-phenol), 4,4′-thiobis-(6-tert.-butyl-2-methylphenol), 4,4′-thiobis-(3,6-di-sec-amylphenol), 4,4′-bis-(2,6-dimethyl-4-hydroxyphenyl)-disulfide.
1.6. Alkylidenebisphenols, for example 2,2′-methylenebis-(6-tert.-butyl-4-methylphenol), 2,2′-methylenebis-(6-tert.-butyl-4-ethylphenol), 2,2′-methylene-bis-[4-methyl-6-(α-methylcyclohexyl)-phenol], 2,2′-methylenebis-(4-methyl-6-cyclohexylphenol), 2,2′-methylenebis-(6-nonyl-4-methylphenol), 2,2′-methylenebis-(4,6-di-tert.-butylphenol), 2,2′-ethylidenebis-(4,6-di-tert.-butyl-phenol), 2,2′-ethylidenebis-(6-tert.-butyl-4-isobutylphenol), 2,2′-methylenebis-[6-(α-methylbenzyl)-4-nonylphenol], 2,2′-methylenebis-[6-(α,α-dimethylbenzyl)-4-nonylphenol], 4,4′-methylenebis-(2,6-di-tert.-butylphenol), 4,4′-methylenebis-(6-tert.-butyl-2-methylphenol), 1,1-bis-(5-tert.-butyl-4-hydroxy-2-methylphenyl)-butane, 2,6-bis-(3-tert.-butyl-5-methyl-2-hydroxybenzyl)-4-methylphenol, 1,1,3-tris-(5-tert.-butyl-4-hydroxy-2-methylphenyl)-butane, 1,1-bis-(5-tert.-butyl-4-hydroxy-2-methylphenyl)-3-n-dodecylmercaptobutane, ethylene glycol bis-[3,3-bis-(3′-tert.-butyl-4′-hydroxyphenyl)-butyrate, bis-(3-tert.-butyl-4-hydroxy-5-methylphenyl)-dicyclopentadiene, bis-[2-(3′-tert.-butyl-2′-hydroxy-5′-methyl-benzyl)-6-tert.-butyl-4-methylphenyl]-terephthalate, 1,1-bis-(3,5-dimethyl-2-hydroxyphenyl)-butane, 2,2-bis-(3,5-di-tert.-butyl-4-hydroxyphenyl)-propane, 2,2-bis-(5-tert.-butyl-4-hydroxy-2-methylphenyl)-4-n-dodecylmercaptobutane, 1,1,5,5-tetra-(5-tert.-butyl-4-hydroxy-2-methylphenyl)-pentane.
1.7. O-, N- and S-benzyl compounds, for example 3,5,3′,5′-tetra-tert.-butyl-4,4′-dihydroxydibenzyl ether, octadecyl-4-hydroxy-3,5-dimethylbenzyl mercapto-acetate, tridecyl-4-hydroxy-3,5-di-tert.-butylbenzyl mercaptoacetate, tris-(3,5-di-tert.-butyl-4-hydroxybenzyl)-amine, bis-(4-tert.-butyl-3-hydroxy-2,6-dimethyl-benzyl)-dithioterephthalate, bis-(3,5-di-tert.-butyl-4-hydroxybenzyl)-sulfide, isooctyl-3,5-di-tert.-butyl-4-hydroxybenzyl mercaptoacetate.
1.8. Hydroxybenzylated malonates, for example dioctadecyl-2,2-bis-(3,5-di-tert.-butyl-2-hydroxybenzyl)-malonate, dioctadecyl-2-(3-tert.-butyl-4-hydroxy-5-methylbenzyl)-malonate, didodecyl-mercaptoethyl-2,2-bis-(3,5-di-tert.-butyl-4-hydroxybenzyl)-malonate, bis-[4-(1,1,3,3-tetramethylbutyl)-phenyl]-2,2-bis-(3,5-di-tert.-butyl-4-hydroxybenzyl)-malonate.
1.9. Aromatic hydroxybenzyl compounds, for example 1,3,5-tris-(3,5-di-tert.-butyl-4-hydroxybenzyl)-2,4,6-trimethylbenzene, 1,4-bis-(3,5-di-tert.-butyl-4-hydroxy-benzyl)-2,3,5,6-tetramethylbenzene, 2,4,6-tris-(3,5-di-tert.-butyl-4-hydroxy-benzyl)-phenol.
1.10. Triazine compounds, for example 2,4-bis-(octylmercapto)-6-(3,5-di-tert.-butyl-4-hydroxyanilino)-1,3,5-triazine, 2-octylmercapto-4,6-bis-(3,5-di-tert.-butyl-4-hydroxyanilino)-1,3,5-triazine, 2-octylmercapto-4,6-bis-(3,5-di-tert.-butyl-4-hydroxyphenoxy)-1,3,5-triazine, 2,4,6-tris-(3,5-di-tert.-butyl-4-hydroxyphenoxy)-1,2,3-triazine, 1,3,5-tris-(3,5-di-tert.-butyl-4-hydroxybenzyl)-isocyanurate, 1,3,5-tris-(4-tert.-butyl-3-hydroxy-2,6-dimethylbenzyl)-isocyanurate, 2,4,6-tris-(3,5-di-tert.-butyl-4-hydroxyphenylethyl)-1,3,5-triazine, 1,3,5-tris-(3,5-di-tert.-butyl-4-hydroxyphenylpropionyl)-hexahydro-1,3,5-triazine, 1,3,5-tris-(3,5-dicyclohexyl-4-hydroxybenzyl)-isocyanurate.
1.11. Acylaminophenols, for example 4-hydroxylauranilide, 4-hydroxystearanilide, octyl-N-(3,5-di-tert.-butyl-4-hydroxyphenyl)-carbamate.
1.12. Esters of β-(3,5-di-tert.-butyl-4-hydroxyphenyl)-propionic acid with monohydric or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)-isocyanurate, N,N′-bis-(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo-[2.2.2]-octane.
1.13 Esters of β-(5-tert.-butyl-4-hydroxy-3-methylphenyl)-propionic acid with monohydric or polyhydric alcohols, for example with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl)-isocyanurate, N,N′-bis-(hydroxyethyl)-oxamide, 3-thiaundecanol, 3-thiapentadecanol, trimethylhexane-diol, trimethylolpropane, 4-hydroxymethyl-1-phospha-2,6,7-trioxabicyclo-[2.2.2]-octane.
1.14. Esters of β-(3,5-dicyclohexyl-4-hydroxyphenyl)-propionic acid with monohydric or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl)-isocyanurate, N,N′-bis-(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo-[2.2.2]-octane.
1.15. Esters of 3,5-di-tert.-butyl-4-hydroxyphenyl acetic acid with monohydric or polyhydric alcohols, for example with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris-(hydroxyethyl)-isocyanurate, N,N′-bis(hydroxyethyl)-oxamide, 3-thiaundecanol, 3-thiapentadecanol, trimethylhexanediol, trimethylolpropane, 4-hydroxymethyl-1-phospha-2,6,7-trioxabicyclo-[2.2.2]-octane.
1.16. Amides of β-(3,5-di-tert.-butyl-4-hydroxyphenyl)-propionic acid, for example N,N′-bis(3,5-di-tert.-butyl-4-hydroxyphenylpropionyl)-hexamethylenediamide, N,N′-bis-(3,5-di-tert.-butyl-4-hydroxyphenylpropionyl)-trimethylenediamide, N,N′-bis-(3,5-di-tert.-butyl-4-hydroxyphenylpropionyl)-hydrazide, N,N′-bis-(2-(3-(3,5-di-tert.-butyl-4-hydroxyphenyl)-propionyloxy)-ethyl)-oxamide (Naugard® XL-1 from Uniroyal).
1.17. Ascorbic acid (vitamin C).
1.18. Amine-type antioxidants, for example N,N′-diisopropyl-p-phenylenediamine, N,N′-di-sec-butyl-p-phenylenediamine, N,N′-bis-(1,4-dimethylpentyl)-p-phenylenediamine, N,N′-bis-(1-ethyl-3-methylpentyl)-p-phenylenediamine, N,N′-bis-(1-methylheptyl)-p-phenylenediamine, N,N′-dicyclohexyl-p-phenylenediamine, N,N′-diphenyl-p-phenylenediamine, N,N′-bis-(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluene-sulfamoyl)-diphenylamine, N,N′-dimethyl-N,N′-di-sec-butyl-p-phenylene-diamine, diphenylamine, N-allyldiphenylamine, 4-isopropoxydiphenylamine, N-phenyl-1-naphthylamine, N-(4-tert.-octylphenyl)-1-naphthylamine, N-phenyl-2-naphthylamine, octylated diphenylamine, for example p,p′-di-tert.-octyl-diphenylamine, 4-n-butylaminophenol, 4-butyrylaminophenol, 4-nonanoylaminophenol, 4-dodecanoylaminophenol, 4-octadecanoylaminophenol, bis-(4-methoxy-phenyl)-amine, 2,6-di-tert.-butyl-4-dimethylaminomethylphenol, 2,4′-diamino-diphenylmethane, 4,4′-diaminodiphenylmethane, N,N,N′,N′-tetramethyl-4,4′-diaminodiphenylmethane, 1,2-bis-[(2-methylphenyl)-amino]-ethane, 1,2-bis-(phenylamino)-propane, (o-tolyl)-biguanide, bis-[4-(1′,3′-dimethylbutyl)-phenyl]-amine, tert.-octylated N-phenyl-1-naphthylamine, a mixture of mono-alkylated and dialkylated tert.-butyl/tert.-octyldiphenylamines, a mixture of monoalkylated and dialkylated nonyldiphenylamines, a mixture of monoalkylated and dialkylated dodecyldiphenylamines, a mixture of monoalkylated and dialkylated isopropyl/isohexyldiphenylamines, a mixture of monoalkylated and dialkylated tert.-butyldiphenylamines, 2,3-dihydro-3,3-dimethyl-4H-1,4-benzo-thiazine, phenothiazine, a mixture of monoalkylated and dialkylated tert.-butyl/tert.-octylphenothiazines, a mixture of monoalkylated and dialkylated tert.-octylphenothiazines, N-allylphenothiazine, N,N,N′,N′-tetraphenyl-1,4-diamino-but-2-ene, N,N-bis-(2,2,6,6-tetramethylpiperid-4-yl)-hexamethylenediamine, bis-(2,2,6,6-tetramethylpiperid-4-yl)-sebacate, 2,2,6,6-tetramethylpiperidin-4-one, 2,2,6,6-tetramethylpiperidin-4-ol. These compounds may be used individually or as mixtures.
1.19. Suitable thiosynergists, such as for example dilauryl thiodipropionate and/or distearyl thiodipropionate.
1.20. Secondary antioxidants, phosphines, phosphine oxides, phosphites and phosphonites, such as for example triphenylphosphine, tri-(2-tert.-butylphenyl)-phosphine, tri-(2,4-di-tert.-butylphenyl)-phosphine, tri-(2,6-di-tert.-butylphenyl)-phosphine, tri-(2,4,6-tri-tert.-butylphenyl)-phosphine, tri-(4-nonylphenyl)-phosphine, tri-1-naphthylphosphine, tri-2-naphthylphosphine and their corresponding oxides, tri-(nonylphenyl)-phosphite, tri-(2,4-ditert.-butylphenyl)-phosphite, 3,9-bis-(2,4-di-tert.-butylphenoxy)-2,4,8,10-tetraoxa-3,9-diphospha-spiro-[5.5]-undecane, 3,9-bis-(2,6-di-tert.-butyl-4-methylphenoxy)-2,4,8,10-tetra-oxa-3,9-diphosphaspiro-[5,5]-undecane, 2,2′-methylenebis-(4,6-di-tert.-butyl-phenyl)-octylphosphite, tetrakis-(2,4-di-tert.-butylphenyl)-(1,1-biphenyl)-4,4′-diylbisphosphonite, 2,2′-ethylidenebis-(4,6-di-tert.-butylphenyl)-fluoro-phosphite, o,o′-dioctadecylpentaerythritol-bisphosphite, tri-(2-((2,4,8,10-tetra-tert.-butyldibenzo-(d,f)-(1,3,2)-dioxa-phosphepin-6-yl)-oxy)-ethyl)-amine, bis-(2,4-di-tert.-butyl-6-methylphenyl)-ethyl-phosphites, 2-butyl-2-ethyl-1,3-propane-diyl-2,4,6-tri-tert.-butylphenyl-phosphites, pentaerythritol-bis-(2,4-dicumyl-phenyl)-phosphite.
2. UV absorbers and light stabilizers
2.1. 2-(2′-hydroxyphenyl)-benzotriazoles, for example 2-(2′-hydroxy-5′-methyl-phenyl)-benzotriazole, 2-(3′,5′-di-tert.-butyl-2′-hydroxyphenyl)-benzotriazole, 2-(5′-tert.-butyl-2′-hydroxypheny])-benzotriazole, 2-(2′-hydroxy-5′-(1,1,3,3-tetramethylbutyl)-phenyl)-benzotriazole, 2-(3′,5′-di-tert.-butyl-2′-hydroxy-phenyl)-5-chlorobenzotriazole, 2-(3′-tert.-butyl-2′-hydroxy-5′-methylphenyl)-5-chlorobenzotriazole, 2-(3′-sec-butyl-5′-tert.-butyl-2′-hydroxyphenyl)-benzo-triazole, 2-(2′-hydroxy-4′-octyloxyphenyl)-benzotriazole, 2-(3′,5′-di-tert-amyl-2′-hydroxyphenyl)-benzotriazole, 2-(3′,5′-bis(a,a-dimethylbenzyl)-2′-hydroxy-phenyl)-benzotriazole, 2-(3′-tert.-butyl-2′-hydroxy-5′-(2-octyloxycarbonylethyl)-phenyl)-5-chlorobenzotriazole, 2-(3′-tert.-butyl-5′-[2-(2-ethylhexyloxy)-carbonylethyl]-2′-hydroxyphenyl)-5-chlorobenzotriazole, 2-(3′-tert.-butyl-2′-hydroxy-5′-(2-methoxycarbonylethyl)phenyl)-5-chlorobenzotriazole, 2-(3′-tert.-butyl-2′-hydroxy-5′-(2-methoxycarbonylethyl)-phenyl)-benzotriazole, 2-(3′-tert.-butyl-2′-hydroxy-5′-(2-octyloxycarbonylethyl)-phenyl)-benzotriazole, 2-(3′-tert.-butyl-5′-(2-(2-ethylhexyloxy)-carbonylethyl)-2′-hydroxyphenyl)-benzotriazole, 2-(3′-dodecyl-2′-hydroxy-5′-methylphenyl)-benzotriazole, 2-(3′-tert.-butyl-2′-hydroxy-5′-(2-isooctyloxycarbonylethyl)-phenylbenzotriazole, 2,2′-methylene-bis-(4-(1,1,3,3-tetramethylbutyl)-6-benzotriazol-2-ylphenol); the trans-esterification product of 2-(3′-tert.-butyl-5′-(2-methoxycarbonylethyl)-2′-hydroxyphenyl)-2H-benzotriazole with polyethylene glycol 300; (R—CH₂CH₂—COO—CH₂CH₂—)₂, where R=3′-tert.-butyl-4′-hydroxy-5′-2H-benzotriazol-2-ylphenyl, 2-(2′-hydroxy-3′-(α,α-dimethylbenzyl)-5′-(1,1,3,3-tetramethylbutyl)-phenyl)-benzotriazole, 2-(2′-hydroxy-3′-(1,1,3,3-tetramethylbutyl)-5′-(α,α-dimethylbenzyl)-phenyl)-benzotriazole.
2.2. 2-hydroxybenzophenones, for example the 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethoxy derivatives.
2.3. Esters of substituted and unsubstituted benzoic acids, such as for example 4-tert.-butylphenyl salicylate, phenyl salicylate, octylphenyl salicylate, dibenzoyl-resorcinol, bis-(4-tert.-butyl-benzoyl)-resorcinol, benzoylresorcinol, 2,4-di-tert.-butylphenyl-3,5-di-tert.-butyl-4-hydroxybenzoate, hexadecyl-3,5-di-tert.-butyl-4-hydroxybenzoate, octadecyl-3,5-di-tert.-butyl-4-hydroxybenzoate, 2-methyl-4,6-di-tert.-butylphenyl-3,5-di-tert.-butyl-4-hydroxybenzoate.
2.4. Acrylates, for example ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.
2.5. Nickel compounds, for example nickel complexes of 2,2′-thiobis-(4-(1,1,3,3-tetramethylbutyl)-phenol), such as the 1:1 or 1:2 complex, with or without additional ligands, such as n-butylamine, triethanolamine or N-cycIo-hexyldiethanolamine, nickel dibutyldithiocarbamate, nickel salts of the monoalkyl esters, for example of the methyl or ethyl ester, of 4-hydroxy-3,5-di-tert.-butylbenzylphosphonic acid, nickel complexes of ketoximes, for example of 2-hydroxy-4-methylphenylundecylketoxime, nickel complexes of 1-phenyl-4-lauroyl-5-hydroxypyrazole, with or without additional ligands.
2.6. Sterically hindered amines, for example bis-(2,2)6,6-tetramethyl-4-piperidyl)-sebacate, bis-(2,2,6,6-tetramethyl-4-piperidyl)-succinate, bis-(1,2,2,6,6-penta-methyl-4-piperidyl)-sebacate, bis-(1-octyloxy-2,2,6,6-tetramethyl-4-piperidyl)-sebacate, bis(1,2,2,6,6-pentamethyl-4-piperidyl), n-butyl-3,5-di-tert.-butyl-4-hydroxybenzyl malonate, the condensate of 1-(2-hydroxyethyl)-2,2,6,6-tetramethyl-4-hydroxypiperidine and succinic acid, linear or cyclic condensates of N,N′-bis-(2,2,6,6-tetramethyl-4-piperidyl)-hexamrethylenediamine and 4-tert.-octylamino-2,6-dichloro-1,3,5-triazine, tris-(2,2,6,6-tetramethyl-4-piperidyl)-nitrilotriacetate, tetrakis-(2,2,6,6-tetramethyl-4-piperidyl)-1,2,3,4-butanetetra-carboxylate, 1,1′-(1,2-ethanediyl)-bis-3,3,5,5-tetramethylpiperazinone, 4-benzoyl-2,2,6,6-tetramethylpiperidine, 4-stearyloxy-2,2,6,6-tetramethyl-piperidine, bis-(1,2,2,6,6-pentamethylpiperidyl)-2-n-butyl-2-(2-hydroxy-3,5-di-tert.-butylbenzyl)-malonate, 3-n-octyl-7,7,9,9-tetramethyl-1,3,8-triazaspiro-[4.5]-decane-2,4-dione, bis-(1-octyloxy-2,2,6,6-tetramethylpiperidyl)-sebacate, bis-(1-octyloxy-2,2,6,6-tetramethylpiperidyl)-succinate, linear or cyclic condensates of N,N′-bis-(2,2,6,6-tetramethyl-4-piperidyl)-hexamethylenediaamine and 4-morpho-lino-2,6-dichloro-1,3,5-triazine, the condensate of 2-chloro-4,6-bis-(4-n-butyl-amino-2,2,6,6-tetramethylpiperidyl)-1,3,5-triazine and 1,2-bis-(3-aminopropyl-amino)-ethane, the condensate of 2-chloro-4,6-bis-(4-n-butylamino-1,2,2,6,6-pentamethylpiperidyl)-1,3,5-triazine and 1,2-bis-(3-aminopropylamino)-ethane, 8-acetyl-3-dodecyl-7,7,9,9-tetramethyl-1,3,8-triazaspiro-[4,5]-decane-2,4-dione, 3-dodecyl-1-(2,2,6,6-tetramethyl-4-piperidyl)-pyrrolidine-2,5-dione, 3-dodecyl-1-(1,2,2,6,6-pentamethyl-4-piperidyl)-pyrrolidine-2,5-dione, a mixture of 4-hexa-decyloxy- and 4-stearyloxy-2,2,6,6-tetramethylpiperidine, a condensation product of N,N′-bis-(2,2,6,6-tetramethyl-4-piperidyl)-hexamethylenediamine and 4-cyclo-hexylamino-2,6-dichloro-1,3,5-triazine, a condensation product of 1,2-bis-(3-aminopropylamino)-ethane and 2,4,6-trichloro-1,3,5-triazine as well as 4-butylamino-2,2,6,6-tetramethylpiperidine (CAS Reg. No. [136504-96-6]); N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro-[4,5]-decane, a reaction product of 7,7,9,9-tetramethyl-2-cycloundecyl-1-oxa-3,8-diaza-4-oxospiro-[4,5]-decane and epichlorohydrin, 1,1-bis-(1,2,2,6,6-pentamethyl-4-piperidyloxycarbonyl)-2-(4-methoxyphenyl)-ethene, N,N′-bis-(formyl)-N,N′-bis-(2,2,6,6-tetramethyl-4-piperidyl)-hexamethylene-diamine, diesters of 4-methoxymethylenemalonic acid with 1,2,2,6,6-pentamethyl-4-hydroxypiperidine, poly-(methylpropyl-3-oxy-4-(2,2,6,6-tetra-methyl-4-piperidyl))-siloxane.
2.7. Oxamides, for example 4,4′-dioctyloxyoxanilide, 2,2′-diethoxyoxanilide, 2,2′-dioctyloxy-5,5′-di-tert.-butoxanilide, 2,2′-didodecyloxy-5,5′-di-tert.-butoxanilide, 2-ethoxy-2′-ethyloxanilide, N,N′-bis(3-dimethylaminopropyl)-oxamide, 2-ethoxy-5-tert.-butyl-2′-ethoxanilide and its mixture with 2-ethoxy-2′-ethyl-5,4′-di-tert.-butoxanilide, mixtures of o- and p-methoxy-disubstituted oxanilides and mixtures of o- and p-ethoxy-disubstituted oxanilides.
2.8.2-(2-hydroxyphenyl)-1,3,5-triazines, for example 2,4,6-tris-(2-hydroxy-4-octyloxyphenyl)-1,3,5-triazine, 2-(2-hydroxy-4-octyloxyphenyl)-4,6-bis-(2,4-dimethylphenyl)-1,3,5-triazine, 2-(2,4-dihydroxyphenyl)-4,6-bis-(2,4-dimethyl-phenyl)-1,3,5-triazine, 2,4-bis-(2-hydroxy-4-propyloxyphenyl)-6-(2,4-dimethyl-phenyl)-1,3,5-triazine, 2-(2-hydroxy-4-octyloxyphenyl)-4,6-bis-(4-methyl-phenyl)-1,3,5-triazine, 2-(2-hydroxy-4-dodecyloxyphenyl)-4,6-bis-(2,4-dimethyl-phenyl)-1,3,5-triazine, 2-(2-hydroxy-4-tridecyloxyphenyl)-4,6-bis-(2,4-dimethyl-phenyl)-1,3,5-triazine, 2-(2-hydroxy-4-(2-hydroxy-3 -butyloxypropoxy)-phenyl)-4,6-bis-(2,4-dimethyl)-1,3,5-triazine, 2-(2-hydroxy-4-(2-hydroxy-3-octyloxy-propyloxy)-phenyl)-4,6-bis-(2,4-dimethyl)-1,3,5-triazine, 2-(4-(dodecyloxy/tri-decyloxy-2-hydroxypropoxy)-2-hydroxyphenyl)-4,6-bis-(2,4-dimethylphenyl)-1,3,5-triazine, 2-(2-hydroxy-4-(2-hydroxy-3-dodecyloxypropoxy)-phenyl)-4,6-bis-(2,4-dimethylphenyl)-1,3,5-triazine, 2-(2-hydroxy-4-hexyloxy)-phenyl-4,6-diphenyl-1,3,5-triazine, 2-(2-hydroxy-4-methoxyphenyl)-4,6-diphenyl-1,3,5-triazine, 2,4,6-tris-(2-hydroxy-4-(3-butoxy-2-hydroxypropoxy)-phenyl)-1,3,5-triazine, 2-(2-hydroxyphenyl)-4-(4-methoxyphenyl)-6-phenyl-1,3,5-triazine, 2-(2-hydroxy-4-(3-(2-ethylhexyl-1-oxy)-2-hydroxypropyloxy)-phenyl)-4,6-bis-(2,4-dimethylphenyl)-1,3,5-triazine.

These compounds may be used individually or in the form of mixtures.
3. Suitable metal deactivators include for example N,N′-diphenyloxamide, N-salicylal-N′-salicyloylhydrazine, N,N′-bis-(salicyloyl)-hydrazine, N,N′-bis-(3,5-di-tert.-butyl-4-hydroxyphenylpropionyl)-hydrazine, 3-salicyloylamino-1,2,4-triazole, bis(benzylidene)-oxalyldihydrazide, oxanilide, isophthaloyl-dihydrazide, sebacoylbisphenylhydrazide, N,N′-diacetyladipoyldihydrazide, N,N′-bis-(salicyloyl)-oxalyldihydrazide, N,N′-bis-(salicyloyl)-thiopropionyl-dihydrazide. These compounds may be used individually or in the form of mixtures.
5. Suitable peroxide traps include for example esters of β-thiodipropionic acid, for example the lauryl, stearyl, myristyl or tridecyl esters, mercaptobenzimidazole, or the zinc salt of 2-mercaptobenzimidazole, zinc dibutyl dithiocarbamate, dioctadecyl disulfide, pentaerythritol tetrakis-(dodecylmercapto)-propionate. These compounds may be used individually or in the form of mixtures.
6. Suitable basic co-stabilizers include for example melamine, polyvinylpyrrolidone, dicyandiamide, triallyl cyanurate, urea derivatives, hydrazine derivates, amines, polyamides, polyurethanes, alkali metal salts and alkaline earth metal salts of higher fatty acids, for example calcium stearate, zinc stearate, magnesium behenate, magnesium stearate, sodium ricinoleate and potassium palmitate, antimony pyrocatecholate or zinc pyrocatecholate. These compounds may be used individually or in the form of mixtures.
7. Suitable nucleating agents include for example inorganic substances that are soluble and meltable, such as phosphates, carbonates or sulfates, preferably of alkaline earth metals; organic compounds such as monocarboxylic acids or polycarboxylic acids and their salts, e.g. 4-tert.-butylbenzoic acid, adipic acid, diphenylacetic acid, sodium succinate or sodium benzoate; polymeric compounds, such as ionic copolymers (ionomers). Particularly preferred are 1,3:2,4-bis-(3′,4′-dimethylbenzylidene)-sorbitol, 1,3:2,4-di-(paramethyldibenzylidene)-sorbitol and 1,3:2,4-di(benzylidene)-sorbitol. These compounds may be used individually or in the form of mixtures.
8. Suitable other additives include for example plasticizers, lubricants, emulsifiers, viscosity modifiers, catalysts, flow improvers, optical brighteners, flameproofing agents, antistatic agents and blowing agents.
9. Suitable buzonftiranones and indolinones are for example those that are disclosed in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4 316 611; DE-A-4 316 622; DE-A-4 316 876; EP-A-0 589 839 or EP-A-0591 102, or 3-(4-(2-acetoxyethoxy)-phenyl)-5,7-di-tert.-butylbenzofuran-2-one, 5,7-di-tert.-butyl-3-(4-(2-stearoyloxyethoxy)-phenyl)-benzofuran-2-one, 3,3′-bis-(5,7-di-tert.-butyl-3-(4-(2-hydroxyethoxy)-phenyl)-benzofuran-2-one), 5,7-di-tert.-butyl-3-(4-ethoxyphenyl)-benzofuran-2-one, 3-(4-acetoxy-3,5-dimethyl-phenyl)-5,7-di-tert.-butylbenzofuran-2-one, 3-(3,5-dimethyl-4-pivaloyloxy-phenyl)-5,7-di-tert.-butylbenzofuran-2-one, 3-(3,4-dimethylphenyl)-5,7-di-tert.-butylbenzofuran-2-one, 3-(2,3-dimethylphenyl)-5.7-di-tert.-butylbenzofuran-2-one, lactone antioxidants such as

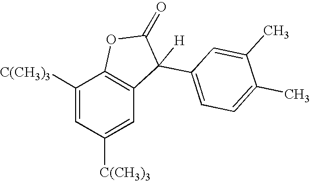

These compounds act for example as antioxidants. They may be used individually or in the form of mixtures.
10. Suitable mold release agents are esters of aliphatic acids and alcohols, for example pentaerythritol tetrastearate and glycerol monostearate, which are used alone or in the form of a mixture, preferably in an amount of 0.02 to 1 wt. %, referred to the weight of the composition.
11. Suitable flame-retarding additives are phosphate esters, i.e. triphenyl phosphate, resorcinol diphosphoric acid ester, bromine-containing compounds such as brominated phosphoric acid esters, brominated oligocarbonates and polycarbonates, as well as salts such as C₄F₉SO₃⁻Na⁺.
12. Suitable antistatic agents are sulfonate salts, for example tetraethylammonium salts of C₁₂H₂₅SO₄³⁻ or C₈F₁₇SO₄³⁻.
13. Suitable colorants are soluble and meltable organic dyes.
14. Compounds that contain epoxy groups, such as 3,4-epoxycyclohexylmethyl-3,4-epoxycyclohexyl carboxylate.
15. Compounds that contain anhydride groups, such as maleic anhydride, succinic anhydride, benzoic anhydride and phthalic anhydride.

The compounds of the groups 14 and 15 act as melt stabilizers. They may be used individually or in the form of mixtures.

Catalysts are understood to include all compounds that alter the kinetics of chemical reactions, for instance increasing the molecular weight of the polymer.

The basic catalysts known in the literature for the melt transesterification process for the production of polycarbonates are used as catalysts, such as for example alkali metal and alkaline earth metal hydroxides and oxides, but also ammonium or phosphonium salts, hereinafter termed onium salts. Onium salts are preferably used, and phosphonium salts are particularly preferably used in the synthesis.

Phosphonium salts within the context of the invention are those of the general formula: 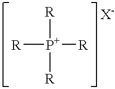
wherein R¹⁻⁴ independently denote C₁-C₁₀-alkyls, C₆-C₁₄-aryls, C₇-C₁₅-aralkyls or C₅-C₆-cycloalkyls, preferably methyl or C₆-C₁₄-aryls, particularly preferably methyl or phenyl, and X⁻ is an anion such as hydroxide, sulfate, hydrogen sulfate, hydrogen carbonate, carbonate or a halide, preferably chloride, or an alkylate or arylate of the formula —OR, where R is a C₆-C₁₄-aryl, C₇-C₁₅-aralkyl or C₅-C₆-cycloalkyl, preferably phenyl.

Preferred catalysts are tetraphenylphosphonium chloride, tetraphenylphosphonium hydroxide and tetraphenylphosphonium phenolate; tetraphenylphosphonium phenolate is particularly preferred.

The catalysts are preferably used in amounts of 10⁻⁸ to 10⁻³ mole, particularly preferably in amounts of 10⁻⁷ to 10⁻⁴ mole, referred to one mole of dihydroxyaryl compound.

Further catalysts may be used alone or in addition to the onium salt as co-catalyst, in order to increase the rate of the polycondensation.

These further catalysts include the alkaline-acting salts of alkali metals and alkaline earth metals, such as hydroxides, alkoxides and aryloxides of lithium, sodium and potassium, preferably hydroxides, alkoxides or aryloxides of sodium. Most particularly preferred are sodium hydroxide and sodium phenolate, but also the disodium salt of 2,2-bis-(4-hydroxyphenyl)-propane.

The amounts of the alkaline-acting salts of alkali metals and alkaline earth metals used alone or as co-catalyst may be in the range from 1 to 500 ppb, preferably 5 to 300 ppb and most particularly preferably 5 to 200 ppb, in each case calculated as sodium and referred to the polymer to be formed.

The alkaline-acting salts of alkali metals and alkaline earth metals may be used already in the production of the oligocarbonates, in other words as the beginning of the synthesis, but may also be added only before the polycondensation, in order to suppress undesired secondary reactions.

It is furthermore also possible to add supplementary amounts of onium catalysts of the same type or of another type before the polycondenrsation.

Inhibitors are understood to mean all compounds that decisively inhibit the kinetics of chemical reactions so as to prevent changes that adversely affect the quality of the polymer. The addition of inhibitors is thus necessary for example after the production of polymers that still contain monomers and reaction products after completion of the reaction, in order to reduce the amounts of low molecular weight compounds by for example thermal processes. The addition of inhibitors is also always necessary if active catalysts remain in the products that are produced and that impair the use properties during the further life cycle of the product.

As inhibitors, acid components such as Lewis acids or Bronsted acids or esters of strong acids are suitable for the polycarbonate production process according to the transesterification process. The pKa value of the acid should not be greater than 5 and is preferably less than 3. The acid components or their esters are added in order to deactivate the reaction mixture, i.e. in the ideal case to stop the reaction completely. The acid component is as a rule employed in equivalent amounts to the amounts of catalyst to be neutralized.

Examples of suitable acid components include: o-phosphoric acid, phosphorous acid, pyrophosphoric acid, hypophosphoric acid, polyphosphoric acids, benzenephosphonic acid, sodium dihydrogen phosphate, boric acid, arylboronic acids, hydrochloric acid (hydrogen chloride), sulfuric acid, ascorbic acid, oxalic acid, benzoic acid, salicylic acid, formic acid, acetic acid, adipic acid, citric acid, benzenesulfonic acid, toluenesulfonic acid, dodecylbenzenesulfonic acid and all other phenyl-substituted benzenesulfonic acids, nitric acid, terephthalic acid, isophthalic acid, stearic acid and other fatty acids, acid chlorides such as phenyl chloroformate, stearyl chloride, acetoxy-BP-A, benzoyl chloride as well as esters, semi-esters and bridged esters of the acids mentioned above, such as for example toluenesulfonic acid esters, phosphoric acid esters, phosphorous acid esters, phosphonic acid esters, dimethyl sulfate, boric acid esters, arylboronic acid esters and other components that generate acids under the influence of water, such as triisooctylphosphine, Ultranox 640 and BDP (bisphenoldiphosphate oligomer).

Preferred in this connection are o-phosphoric acid, phosphorous acid, pyrophosphoric acid, hypophosphoric acid, polyphosphoric acids, benzenephosphonic acid, sodium dihydrogen phosphate, boric acid, arylboronic acids, benzoic acid, salicylic acid, benzenesulfonic acid, toluenesulfonic acid, dodecylbenzenesulfonic acid and all other phenyl-substituted benzenesulfonic acids, acid chlorides such as phenyl chloroformate, stearyl chloride, acetoxy-BP-A, benzoyl chloride as well as esters, semi-esters and bridged esters of the acids mentioned above, such as for example toluenesulfonic acid esters, phosphoric acid esters, phosphorous acid esters, phosphonic acid esters, boric acid esters, arylboronic acid esters and other components that generate acids under the influence of water, such as triisooctylphosphine, Ultranox 640 and BDP.

Particularly preferred are o-phosphoric acid, pyrophosphoric acid, polyphosphoric acids, benzenephosphonic acid, benzoic acid, benzenesulfonic acid, toluenesulfonic acid, dodecylbenzenesulfonic acid and all other phenyl-substituted benzenesulfonic acids as well as esters, semi-esters and bridged esters of the acids mentioned above, such as for example toluenesulfonic acid esters, phosphoric acid esters, phosphorous acid esters, phosphonic acid esters and other components that generate acids under the influence of water, such as triisooctylphosphine, Ultranox 640 and BDP.

Most particularly preferred are o-phosphoric acid, pyrophosphoric acid, benzenesulfonic acid, toluenesulfonic acid, dodecylbenzenesulfonic acid and all other phenyl-substituted benzenesulfonic acids as well as esters, semi-esters and bridged esters of the acids mentioned above, such as for example toluenesulfonic acid esters and phosphoric acid esters.

Suitable solvents are those that do not interfere in the process, are chemically inert, and rapidly evaporate.

Suitable solvents include all organic solvents with a boiling point at standard pressure of 30° to 300° C., preferably 30° to 250° C. and particularly preferably 30° to 200° C., as well as also water, including in this connection water of crystallization. Preferably those compounds are chosen that are present in the respective processes.

Solvents may include, apart from water, also alkanes, cycloalkanes and aromatic compounds, which may also be substituted. The substituents may be aliphatic, cycloaliphatic or aromatic radicals in various combinations, as well as halogens or an hydroxyl group. Heteroatoms, such as for example oxygen, may also be bridge members between aliphatic, cycloaliphatic or aromatic radicals, in which connection the radicals may be identical or different. Further solvents may also be ketones and esters of organic acids, as well as cyclic carbonates.

Examples include, in addition to water, also n-pentane, n-hexane, n-heptane and their isomers, cyclohexane, toluene and xylene, methylene chloride, ethyl chloride, ethylene chloride, chlorobenzene, methanol, ethanol, propanol, butanol and their isomers, phenol, o-, m- and p-cresol, diethyl ether, dimethyl ketone, polyethylene glycols, polypropylene glycols, ethyl acetate, ethylene carbonate and propylene carbonate.

The polycarbonates obtainable according to the process described in the invention may be processed on known equipment, for example on extruders or injection molding machines, into various molded articles.

### EXAMPLES

Determination of the Characteristic Values:

Relative Viscosity:

The relative viscosity is determined as the quotient of the viscosity of the solvent and the viscosity of the polymer dissolved in this solvent. The relative viscosity was measured at 25° C. at a concentration of 5 g/l in dichloromethane.

OH Terminal Group:

The content of phenolic OH is determined by IR measurement. To this end a difference measurement is made of a solution of 2 g of polymer in 50 ml of dichloromethane compared to pure dichloromethane, and the extinction difference is determined at 3582 cm⁻¹.

Residual Monomers:

In order to determine the content of the residual monomers the sample is dissolved in dichloromethane and then precipitated with acetone/methanol. After separating the precipitated polymer, the filtrate is concentrated by evaporation. The quantification of the residual monomers is carried out by reverse phase chromatography in a solvent gradient of 0.04% phosphoric acid/acetonitrile. Detection is made by UV.

YI (Yellowness Index):

The YI value is determined according to ASTM E 313 on 4 mm-thick injection-molded samples. The injection molding temperature is 300° C.

Determination of the GMS Total Content Free GMS and GMS Carbonate:

The term GMS denotes a mixture of glycerol monopalmitate and glycerol monostearate.

The GMS total content consists of the content of free GMS, the content of GMS carbonate and the content of incorporated GMS. The last is determined by a difference calculation.

Part of the sample is hydrolyzed under alkaline conditions at about 80° C. and then adjusted to about pH 1 with hydrochloric acid. This solution is extracted with tert.-butyl methyl ether and the extract is dried. After derivatization, the compound is analyzed by gas chromatography on a capillary column in conjunction with a flame ionization detector. The quantitative evaluation is made via an internal standard and gives the total content of GMS.

Another part of the sample is dissolved in dichloromethane and derivatized. After gas chromatography separation on a capillary column and detection by means of a flame ionization detector, the quantitative evaluation is made via an internal standard. The contents of free GMS and GMS carbonate are obtained.

The following examples are intended to illustrate the present invention without however restricting its scope:

### Example 1

a) Preparation of Polycarbonate Melt

8,600 kg/hour of melt mixture consisting of 4,425 kg of diphenyl carbonate/hour (20,658 mole/hour) and 4,175 kg of bisphenol A/hour (18,287 mole/hour) are pumped from a receiver, with the addition of 0.52 kg of the phenol adduct of tetraphenylphosphonium phenolate with 65.5% tetraphenylphosphonium phenolate/hour (0.786 mole/hour; i.e. 0.0043 mole %) dissolved in 4.5 kg of phenol/hour, through a heat exchanger, heated to 190° C., and fed through a residence column at 12 bar and 190° C. The mean residence time is 50 minutes. The melt is then passed through a pressure release valve into a separator under a pressure of 200 mbar. The discharged melt is reheated to 189° C. in a falling film evaporator, likewise under a pressure of 200 mbar, and collected in a receiver. After a residence time of 20 minutes the melt is pumped into the next three, similarly constructed, stages. The conditions in the 2^{nd}/3^{rd}/4^{th} stage are 100/74/40 mbar; 218/251/276° C. and 20/10/10 minutes. The oligomer formed has a relative viscosity of 1.09. All vapors are fed through pressure regulating devices into a column maintained under a vacuum, and are discharged as condensates.

The oligomer is then condensed in a connected cage reactor at 278° C. and 3.0 mbar at a residence time of 45 minutes to form a higher molecular weight product. The relative viscosity is 1.195. The vapors are condensed.

b) Addition of Additives According to the Invention

From the melt stream, which is fed into a further cage reactor, 150 kg of melt/hour are fed from the main melt line under excess pressure through a valve into an annular nozzle of 200 mm diameter. This nozzle is located centrally in a heated pressure vessel, on the floor of which is arranged a gear-type pump. 925 g of 1% phosphoric acid/hour are fed from above through an externally thermally insulated lance thermostatically controlled at 80° C. and at the end of which is a hollow-cone nozzle consisting of the material 2.4605. The nozzle is introduced sufficiently far so that the sprayed phosphoric acid impacts only on the melt stream that is formed and not on hot metal surfaces. The water vapor that is formed is discharged together with roughly replenishing metered-in nitrogen through a valve so that a pressure of about 10 bar is maintained. The melt stream impacting on the gear-type pump is recycled directly to the main stream through a static mixer with a length-to-diameter ratio of 20. Directly following the mixing the phosphoric acid is homogeneously distributed in the overall melt stream by means of a further static mixer.

The melt treated in this way is further subjected to the process conditions in a further cage reactor at 284° C., 0.7 mbar and at a mean residence time of 130 minutes, and is discharged and granulated.

The vapors are condensed in the vacuum unit and following units.

After a 14-day production run no traces of corrosion are found in the equipment. The relevant material parameters of the resulting product are given in Table 1. These show that the same amount of pure phosphoric acid has an improved effect compared to the following comparison example.

### Comparison Example 1

The polycarbonate is produced under the same conditions as in Example 1a).

Addition of Additive:

From the melt stream, which is fed into a further cage reactor, a partial stream of 150 kg of melt/hour is branched off by means of a gear-type pump, 1 85 g of 5% aqueous phosphoric acid/hour is added through a lance consisting of the material 2.4605, which is directly connected to the melt line, and the mixture is fed through a static mixer with a length-to-diameter ratio of 20 and recycled to the main melt stream. Directly after the mixing, the phosphoric acid is homogeneously distributed in the overall melt stream by means of a further static mixer.

The melt treated in this way is further subjected to the process conditions in a further cage reactor at 284° C., 0.7 mbar and at a mean residence time of 130 minutes, and is discharged and granulated.

The vapors are condensed in the vacuum unit and following units.

The polycarbonate obtained has the characteristic data shown in Table 1.

After a 3-day run the lance is dismantled. Clear signs of corrosion are found at the outlet point and crossover point of the phosphoric acid. Likewise, the inlet region of the static mixer consisting of the material 1.4571 is clearly affected by corrosion.

TABLE 1

| | | Phenolic | | | | |
|---|---|---|---|---|---|---|
| | Relative | OH | DPC | BPA | Phenol | |
| | Viscosity | [ppm] | [ppm] | [ppm] | [ppm] | YI |
| Example 1 | 1.198 | 270 | 23 | 4 | 39 | 1.83 |
| Comparison | 1.201 | 255 | 71 | 6 | 56 | 2.06 |
| example 1 | | | | | | |

DPC = Diphenylcarbonate,
BPA = Bisphenol A,

### Example 2

A polycarbonate melt stream of 4,600 kgihour to which phosphoric acid has previously been added as in Example 1 and in which the residual monomers were reduced, is mixed with GMS (mixture of glycerol monopalmitate and glycerol monostearate) according to the process of the present invention in order to improve the mold release behavior. To this end 150 kg of polycarbonate melt/hour at 287° C. are fed from the melt line under pressure behind the production unit and through a valve to an annular nozzle of 200 mm diameter, which is located centrally in a heated pressure vessel on the floor of which is arranged a gear-type pump. 1,475 g of GMS/hour are fed from above through an externally thermally insulated lance thermostatically controlled at 90° C., at the end of which is arranged a rotating plate atomiser. The plate atomiser is introduced sufficiently far so that the sprayed GMS melt impacts only on the melt stream that is formed. Nitrogen for example is fed through a valve into the vessel in order to render the contents inert. The melt stream impacting on the gear-type pump is recycled directly to the main stream through a static mixer with a length-to-diameter ratio of 20. The mixing point of the melt streams is followed directly in the flow direction by a static mixer, which homogeneously distributes the additive in the whole melt stream. Following this the melt is discharged and granulated. The values measured in the product are shown in Table 2. The high value of free GMS is advantageous.

### Comparison Example 2

A polycarbonate melt stream of 4,600 kg/hour to which phosphoric acid has previously been added as in Example 1 and in which the residual monomers were reduced, is mixed with GMS in order to improve the mold release behaviour. To this end 400 kg of polycarbonate granules/hour are melted at 290° C. in a twin-shaft extruder with a shaft diameter of 70 mm. 1,475 g of liquid GMS/hour with a melting point of 90° C. are metered through a line into an open housing of the extruder, through which the polycarbonate melt is already conveyed. Nitrogen for example is fed into the open housing in order to render the contents inert. The melt leaving the extruder is entrained by a gear-type pump and pumped into the melt stream behind the production unit, which is at a temperature of 288° C. The mixing point of the melt streams is followed directly in the flow direction by a static mixer, which homogeneously distributes the additive in the whole melt stream. Following this the melt is discharged and granulated.

The values measured in the product are shown in Table 2.

TABLE 2

| | | GMS Total | | GMS | |
|---|---|---|---|---|---|
| | Relative | Content | Free GMS | Carbonate: | |
| | Viscosity | [ppm] | [ppm] | [ppm] | YI |
| Example 2 | 1.201 | 320 | 255 | <30 | 1.84 |
| Comparison | 1.199 | 320 | 60 | 105 | 2.13 |
| example 2 | | | | | |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for making a thermoplastic molding composition comprising
(i) forming a vertically falling stream of molten polymer, and
(ii) bringing at least one additive in solid or liquid states, in solution, in the form of a dispersion or in suspension into contact with at least a part of the surface of said stream and
to introduce the additive in said stream to produce a combined stream, and
(iii) introducing the combined stream into a pump to form a pre-mix and
(iv) introducing the premix into a mixer to form a homogeneous polymer melt.

2. The process of claim 1 wherein the additive is in the form of molten liquid.

3. The process of claim 1 wherein the additive is in the form of a solution including a solvent.

4. The process of claim 3 wherein the boiling point of the solvent is sufficiently low to cause its immediate evaporation upon said contact.

5. The process of claim 1 wherein the vertically falling stream is in the form of a hose and where the additive is brought into contact by spraying it through a hollow cone nozzle positioned within said hose.

6. The process of claim 5 wherein the contact is by spraying through a plate atomiser.

7. The process of claim 1 wherein the pump is a gear-typ pump and the mixer is a static mixer.

8. The process of claim 1 wherein the mixer is an extruder.
